(19) United States
(12) Patent Application Publication
(10) Pub. No.: US 2026/0281852 A1
(43) Pub. Date: Sep. 17, 2026

(54) NEIGHBOR CELL MEASUREMENT

(71) Applicant: Samsung Electronics Co., Ltd., Suwon-si (KR)

(72) Inventors: Anil Agiwal, McKinney, TX (US); Kyeongin Jeong, Frisco, TX (US); Shiyang Leng, Little Elm, TX (US)

(21) Appl. No.: 19/554,390

(22) Filed: Mar. 2, 2026

Related U.S. Application Data
(60) Provisional application No. 63/772,001, filed on Mar. 14, 2025.
(60) Provisional application No. 63/799,936, filed on May 5, 2025.
(60) Provisional application No. 63/844,481, filed on Jul. 15, 2025.
(60) Provisional application No. 63/960,065, filed on Jan. 14, 2026.

(51) Int. Cl. H04W 36/08; H04W 36/00

(52) U.S. Cl. CPC H04W 36/08; H04W 36/0061

(57) ABSTRACT

A method of operating a user equipment (UE) includes receiving (i) a configuration of a layer 1 (L1)/layer 2 (L2) triggered mobility (LTM) candidate cell and (ii) a configuration of one or more secondary cells (SCells) of the LTM candidate cell. The method also includes receiving a medium access control (MAC) control element (CE), wherein the MAC CE is an LTM cell switch MAC CE for switching to the LTM candidate cell, and activating at least one SCell of the LTM candidate cell based on the MAC CE.

### CROSS-REFERENCE TO RELATED APPLICATION(S) AND CLAIM OF PRIORITY

This application claims priority under 35 U.S.C. § 119(e) to U.S. Provisional Patent Application No. 63/772,001 filed on Mar. 14, 2025, U.S. Provisional Patent Application No. 63/799,936 filed on May 5, 2025, U.S. Provisional Patent Application No. 63/844,481 filed on Jul. 15, 2025, and U.S. Provisional Patent Application No. 63/960,065 filed on Jan. 14, 2026. The above-identified provisional patent applications are hereby incorporated by reference in their entirety.

### TECHNICAL FIELD

This disclosure relates generally to wireless networks. More specifically, this disclosure relates to neighbor cell measurement.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for neighbor cell measurement.

In one embodiment, a method of operating a user equipment (UE) is provided. The method includes receiving (i) a configuration of a layer 1 (L1)/layer 2 (L2) triggered mobility (LTM) candidate cell and (ii) a configuration of one or more secondary cells (SCells) of the LTM candidate cell. The method also includes receiving a medium access control (MAC) control element (CE), wherein the MAC CE is an LTM cell switch MAC CE for switching to the LTM candidate cell, and activating at least one SCell of the LTM candidate cell based on the MAC CE.

In another embodiment, a method of operating a base station (BS) is provided. The method includes transmitting (i) a configuration of a LTM candidate cell and (ii) a configuration of one or more SCells of the LTM candidate cell. The method also includes transmitting a MAC CE, wherein the MAC CE is an LTM cell switch MAC CE for switching to the LTM candidate cell, and activating at least one SCell of the LTM candidate cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4A illustrates an example next generation radio access network (NG-RAN) overall architecture according to embodiments of the present disclosure;

FIG. 4B illustrates an example architecture for gNB-CU-CP and gNB-CU-UP separation according to embodiments of the present disclosure;

FIG. 5 illustrates example signaling procedures for inter-gNB handover according to embodiments of the present disclosure;

FIG. 6 illustrates an example procedure for LTM according to embodiments of the present disclosure;

FIG. 7 illustrates an example of SSB transmission according to embodiments of the present disclosure;

FIG. 8 illustrates an example procedure for neighbor cell measurement according to embodiments of the present disclosure;

FIG. 9 illustrates an example procedure for SCell on demand SSB transmission according to embodiments of the present disclosure;

FIG. 10 illustrates an example OD-SSB MAC-CE according to embodiments of the present disclosure;

FIG. 11 illustrates another example OD-SSB MAC-CE according to embodiments of the present disclosure;

FIG. 12 illustrates an example procedure for lower layer triggered mobility according to embodiments of the present disclosure;

FIG. 13 illustrates another example procedure for lower layer triggered mobility according to embodiments of the present disclosure;

FIG. 14 illustrates an example method for mobility with secondary cell activation according to embodiments of the present disclosure; and

FIG. 15 illustrates another example method for mobility with secondary cell activation according to embodiments of the present disclosure.

### DETAILED DESCRIPTION

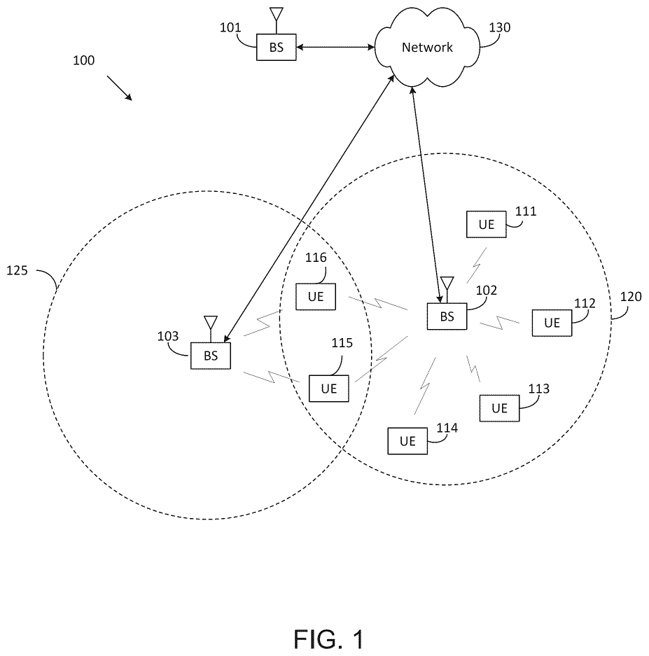

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for neighbor cell measurement. In certain embodiments, one or more of the gNBs 101-103 includes circuitry, programing, or a combination thereof, to support neighbor cell measurement in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

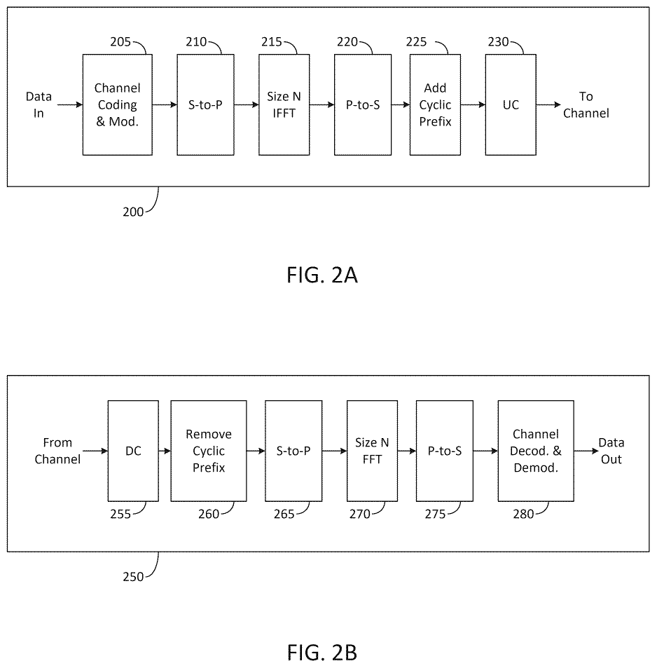

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support neighbor cell measurement as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

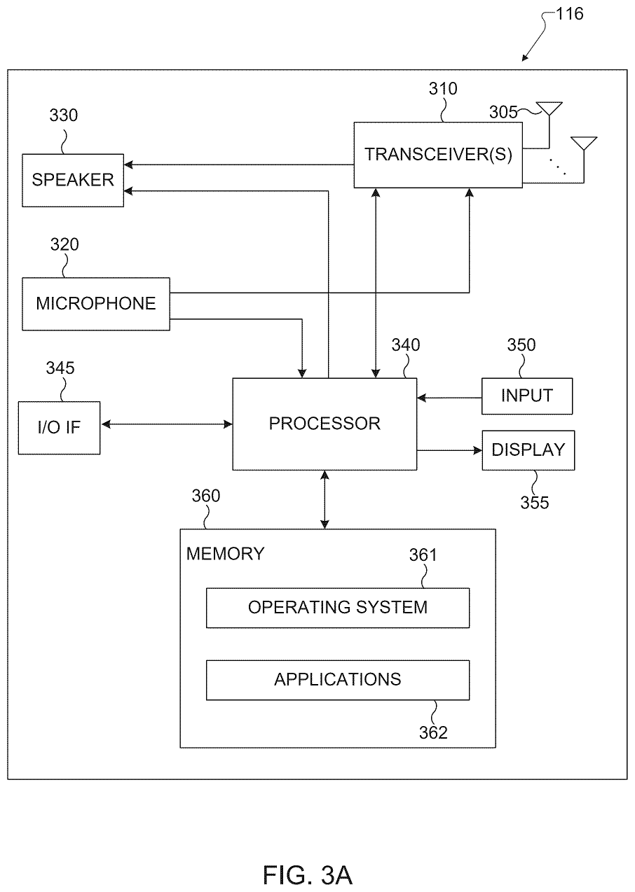

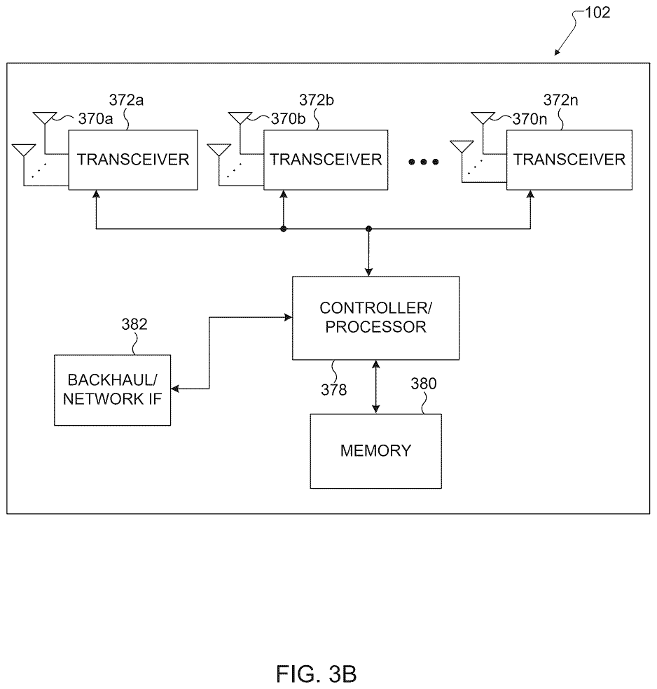

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for neighbor cell measurement as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support neighbor cell measurement as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports not only lower frequency bands but also higher frequency (mmWave) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave, terahertz) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well as dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window, and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state or for a SIB1 request or for an SI request. Several types of random-access procedure are supported such as contention based random access, contention free random access and each of these can be one of 2 step or 4 step random access.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the medium access control (MAC) entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

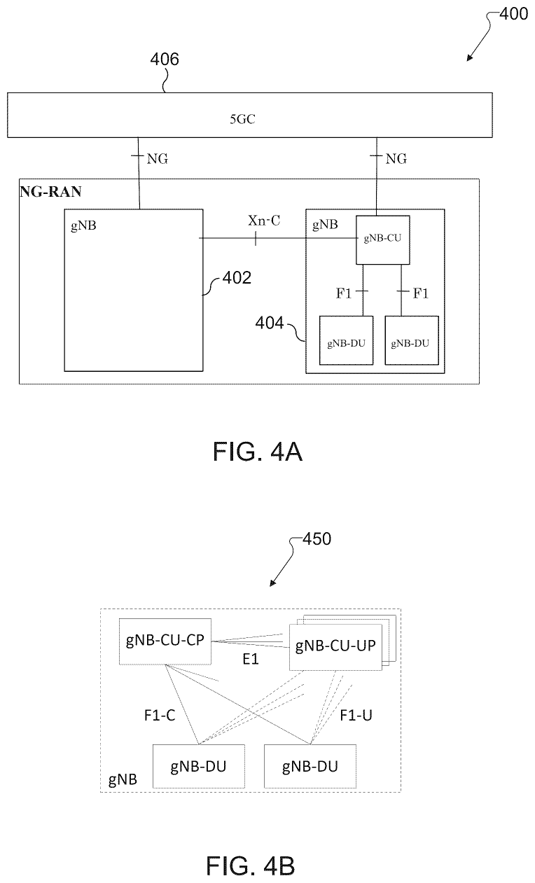

FIG. 4A illustrates an example next generation radio access network (NG-RAN) overall architecture 400 according to embodiments of the present disclosure. The embodiment of an NG-RAN overall architecture of FIG. 4A is for illustration only. Different embodiments of an NG-RAN overall architecture could be used without departing from the scope of this disclosure.

In the example of FIG. 4A, the NG-RAN comprises a set of gNBs 402 and 404 connected to the 5G core (5GC) 406 through NG interfaces. gNBs 402 and 404 can be interconnected through an Xn interface. A gNB may comprise a gNB-central unit (CU) and one or more gNB-distributed unit(s) (DU[s]). A gNB-CU and a gNB-DU are connected via an F1 interface. NG, Xn and F1 interfaces are logical interfaces.

Although FIG. 4A illustrates an example NG-RAN overall architecture 400, various changes may be made to FIG. 4A. For example, architecture 400 could include additional gNBs, different interfaces, etc. according to particular needs.

FIG. 4B illustrates an example architecture 450 for gNB-CU-control plane (CP) and gNB-CU-user plane (UP) separation according to embodiments of the present disclosure. The embodiment of gNB-CU-CP and gNB-CU-UP separation of FIG. 4B is for illustration only. Different embodiments of an architecture for gNB-CU-CP and gNB-CU-UP separation could be used without departing from the scope of this disclosure.

As shown in FIG. 4B, a gNB may comprise a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP. One gNB-DU can be connected to multiple gNB-CU-UPs under the control of the same gNB-CU-CP. One gNB-CU-UP can be connected to multiple DUs under the control of the same gNB-CU-CP.

Although FIG. 4B illustrates an example architecture 450 for gNB-CU-CP and gNB-CU-UP separation, various changes may be made to FIG. 450. For example, the gNB could include any number of UPs, DUs, etc. according to particular needs.

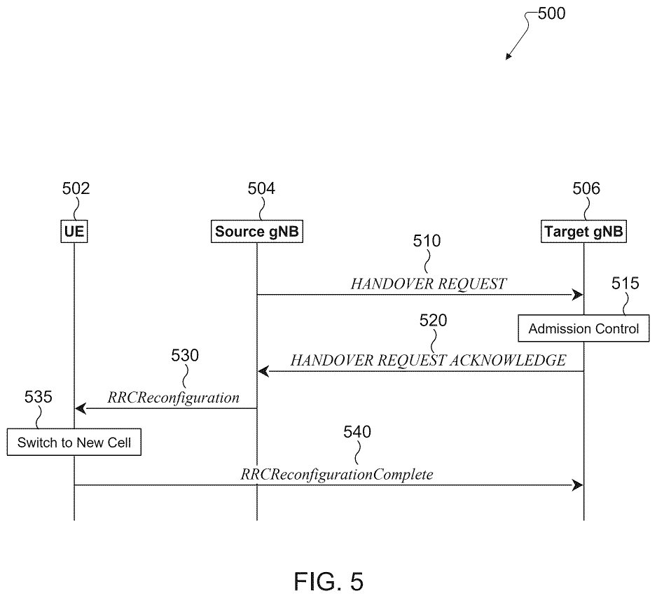

In the next generation wireless communication system (e.g., 5G, beyond 5G, 6G), there are two types of mobility: cell level mobility and beam level mobility. Cell Level Mobility utilizes explicit RRC signaling to be triggering (i.e., handover). For inter-gNB handover, the signaling procedures comprise at least the components shown in FIG. 5.

FIG. 5 illustrates example signaling procedures 500 for inter-gNB handover according to embodiments of the present disclosure. An embodiment of the signaling procedures illustrated in FIG. 5 are for illustration only. One or more of the components illustrated in FIG. 5 may be implemented in specialized circuitry configured to perform the noted functions or one or more of the components may be implemented by one or more processors executing instructions to perform the noted functions. Other embodiments of signaling procedures for inter-gNB handover could be used without departing from the scope of this disclosure.

In the example of FIG. 5, source gNB 504 initiates handover and issues a HANDOVER REQUEST 510 over an Xn interface to a target gNB 506. Target gNB performs admission control at step 515 and provides a new RRC configuration as part of a HANDOVER REQUEST ACKNOWLEDGE 520. Source gNB 504 provides the RRC configuration to UE 502 by forwarding the RRCReconfiguration message 530 received in the HANDOVER REQUEST ACKNOWLEDGE 520. The RRCReconfiguration message 530 includes at least cell ID and all information required to access the target cell so that the UE 502 can access the target cell without reading system information. For some cases, the information required for contention-based and contention-free random access can be included in RRCReconfiguration message 530. The access information to the target cell may include beam specific information, if any. At step 535, UE 502 moves the RRC connection to target gNB 506 and replies with the RRCReconfigurationComplete message 540. The example of FIG. 5 may be referred to as a network controlled or network initiated handover procedure.

Although FIG. 5 illustrates one example of signaling procedures 500 for inter-gNB handover, various changes may be made to FIG. 5. For example, while shown as a series of steps, various steps in FIG. 5 could overlap, occur in parallel, occur in a different order, occur any number of times, be omitted, or replaced by other steps.

In addition to network controlled/network initiated handover, the next generation wireless communication system (e.g., 5G, beyond 5G, 6G) also supports conditional handover and dual active protocol stack (DAPS) handover. In the case of conditional handover, the network can configure one or more candidate cells for conditional handover and one or more L3 measurement based events based on which UE decides to perform a conditional handover procedure. In the case of DAPS handover, the UE continues the downlink user data reception from the source gNB until releasing the source cell and continues the uplink user data transmission to the source gNB until a successful random access procedure to the target gNB.

Layer 1 (L1)/layer 2 (L2) triggered mobility, also referred to herein as lower layer triggered mobility (LTM), is a procedure in which a gNB receives L1 measurement report(s) from a UE, and on the basis of the L1 measurement report(s) the gNB changes the UE's serving cell by a cell switch command signaled via a MAC CE. The cell switch command indicates an LTM candidate cell configuration that the gNB previously prepared and provided to the UE through RRC signaling. Then the UE switches to the target cell according to the cell switch command. The LTM procedure can be used to reduce mobility latency.

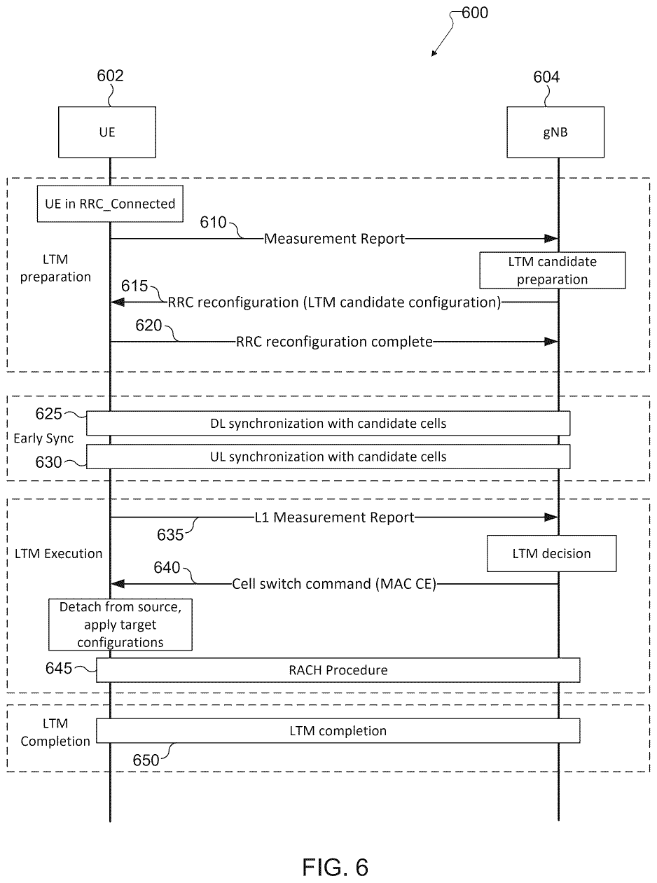

FIG. 6 illustrates an example procedure for LTM 600 according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 6, procedure 600 begins at step 610. At step 610, UE 602, which is in an RRC connected state sends a MeasurementReport message to gNB 604. gNB 604 then decides to configure LTM and initiates candidate cell(s) preparation.

At step 615, gNB 604 transmits an RRCReconfiguration message to UE 602 including the LTM candidate cell configurations of one or multiple candidate cells.

At step 620, UE 602 stores the LTM candidate cell configurations and transmits an RRCReconfigurationComplete message to gNB 604.

At step 625, UE 602 may perform DL synchronization with candidate cell(s) before receiving a cell switch command.

At step 630, if requested by the network, UE 602 performs early TA acquisition with candidate cell(s) before receiving the cell switch command. This is done via contention free random access (CFRA) triggered by a PDCCH order from the source cell, following which UE 602 sends a preamble towards the indicated candidate cell. In order to minimize the data interruption of the source cell due to the CFRA towards the candidate cell(s), UE 602 doesn't receive a RAR for the purpose of TA value acquisition and the TA value of the candidate cell is indicated in the cell switch command. UE 602 doesn't maintain the TA timer for the candidate cell and relies on network implementation to guarantee the TA validity.

At step 635, UE 602 performs L1 measurements on the configured candidate cell(s) and transmits L1 measurement reports to the gNB.

At step 640, gNB 604 decides to execute cell switch to a target cell and transmits a MAC CE triggering cell switch by including the candidate configuration index of the target cell. UE 602 switches to the target cell and applies the configuration indicated by the candidate configuration index.

At step 645, UE 602 performs a random access procedure towards the target cell if UE does not have valid TA of the target cell.

At step 650, UE 602 completes the LTM cell switch procedure by sending a RRCReconfigurationComplete message to the target cell. If UE 602 has performed a RA procedure in step 7, UE 602 considers that the LTM execution is successfully completed when the random access procedure is successfully completed. For RACH-less LTM, UE 602 considers that the LTM execution is successfully completed when the UE determines that the network has successfully received its first UL data. UE 602 determines successful reception of its first UL data by receiving a PDCCH addressing UE 602's C-RNTI in the target cell, which schedules a new transmission following the first UL data.

Although FIG. 6 illustrates one example procedure for LTM 600, various changes may be made to FIG. 6. For example, while shown as a series of steps, various steps in FIG. 6 could overlap, occur in parallel, occur in a different order, occur any number of times, be omitted, or replaced by other steps.

In some wireless communication systems, a UE can be configured with SSB based radio resource management (RRM) measurement to discover SCell(s) and/or update/change SCells. The periodic transmission of SSB affects the network energy consumption. For network energy savings, on periodic SSB is not transmitted in the SCell. Upon an on demand SSB trigger, SSBs are periodically transmitted.

For SCell change, a measurement object for frequency of a configured/activated SCell and measurement report for event triggered reporting for event A6 (Neighbor becomes offset better than SCell) can be configured. A measurement configuration identified by a measurement identity is configured for this measurement object and measurement report. For this measurement configuration, the UE measures the SCell corresponding to the frequency in the measurement object. The UE also detects and measures neighboring cells on the frequency in the measurement object. The SCell measurements and neighbor cell measurements are then used to evaluate whether event A6 is met or not. Under these circumstances, if an SCell is not configured with on SSBs and is configured with on demand SSB, SCell measurements cannot be performed until on demand SSB is activated, but the UE continues to measure the neighbor cells on the frequency of this SCell as the measurement configuration includes a measurement object corresponding to the frequency of this SCell. This leads to unnecessary energy consumption in the UE. Various embodiments of the present disclosure provide mechanisms for reduced UE energy consumption.

As noted above, in some wireless communication systems, a UE can be configured with SSB based RRM measurement to discover SCell(s). In such communication systems, a UE reports the RRM measurement results to the gNB on the quality of the measured SSB. The gNB can further provide the SCell configuration by RRC to the UE. At the time of configuration, the SCell can be initially activated or deactivated. If the SCell is deactivated, the gNB can activate the SCell by an SCell activation command via a MAC CE. The UE uses the SCell's SSB (or TRS if configured) for AGC and synchronization purposes to prepare for transmitting or receiving data on the activated SCell. After the SCell is activated, the UE can still use the SSB to re-synchronize with the SCell, based on the UE's implementation.

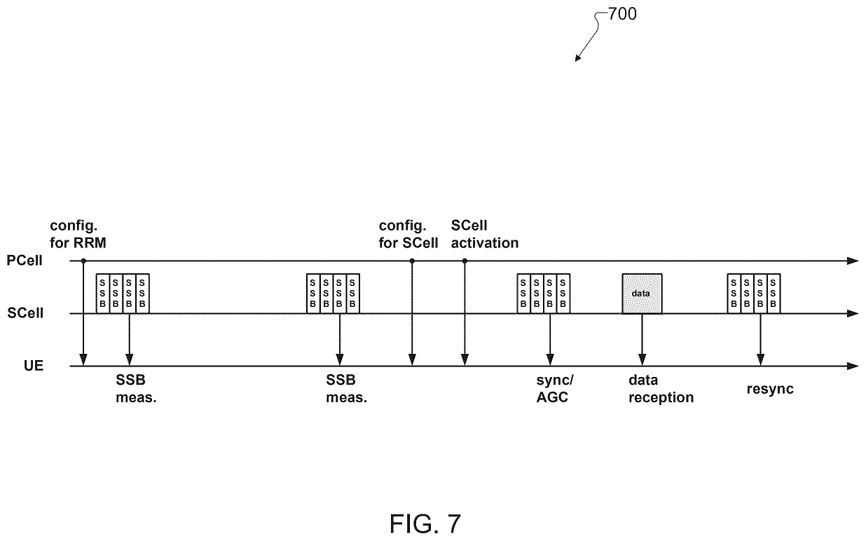

FIG. 7 illustrates an example of SSB transmission 700 according to embodiments of the present disclosure. The embodiment of SCell transmission of FIG. 7 is for illustration only. Different embodiments of SCell transmission could be used without departing from the scope of this disclosure.

In the example of FIG. 7, which may correspond to a NR procedure for SCell SSB transmission, the SSB is transmitted by the SCell and is periodic. In the case of an SSB-less SCell, operation is same except that SSB measurements of a reference serving cell (SpCell or another SCell) are used for the SSB-less SCell.

Although FIG. 7 illustrates one example of SCell transmission 700, various changes may be made to FIG. 7. For example, various changes to the periodicity could be made, etc. according to particular needs.

As noted above, the periodic transmission of SSB for SCell operation affects the network energy consumption. For network energy savings two cases can be considered for on demand (OD) SSB transmission in an SCell:
Case #1: No always-on SSB on the cell. Upon an on demand SSB trigger, SSBs are periodically transmitted.
Case #2: SSBs are periodically transmitted in an SSB burst/window. On demand SSB can be additionally provided. Note that periodic transmission can be at a longer periodicity to reduce energy consumption, but this affects performance ((re)sync/AGC delay, etc.). Additional on demand SSB can improve performance.

A gNB can trigger on demand SSB for one or more configured SCells.
On demand SSB can be triggered when an SCell is configured to a UE but before the UE receives an SCell activation command.
On demand SSB can be triggered when a UE receives an SCell activation command
On demand SSB can be triggered after a UE receives an SCell activation command until SCell activation is completed
On demand SSB can be triggered when or after SCell activation is completed and an SCell is activated

For explicit activation/deactivation (A/D), an OD-SSB MAC-CE includes a fixed sized bitmap to indicate whether OD-SSB is activated in each SCell. For each A/D bit: “1” means activation, while “0” means deactivation for an explicit deactivation case. For explicit activation/deactivation, the OD-SSB MAC-CE supports two formats: one format indicates up to 7 SCells and the other format indicates up to 31 SCells. An OD-SSB MAC-CE includes a configuration index for each SCell activating OD-SSB.

An OD-SSB MAC-CE may include a Cj field. The Cj field is set to 1 to indicate that on demand SSB for an SCell identified by ServCellIndex is activated. The Cj field is set to 0 to indicate that on demand SSB for an SCell identified by ServCellIndex j is deactivated. Since the MAC CE is for (de) activation for multiple SCells, the following are the valid scenarios
Scenario 1: A UE receives a MAC CE with a Cj bit set to 0 for an SCell for which OD-SSB is currently deactivated. This is straightforward and the UE does not need to take any action for the jth SCell.
Scenario 2: A UE receives a MAC CE with a Cj bit set to 1 for an SCell for which OD-SSB is currently deactivated. This is also straightforward. In this case OD-SSB is activated for the jth SCell and the UE applies the OD-SSB configuration corresponding to a configuration index included in the MAC CE.
Scenario 3: A UE receives a MAC CE with a Cj bit set to 0 for an SCell for which OD-SSB is currently activated. In this scenario, the UE operation is not straightforward. For example, the UE does not know how to handle the implicit deactivation (i.e., the parameter od-ssb-nrofBurst is configured and it indicates a number of SSB bursts after which the OD-SSB is implicitly deactivated) configured for the jth SCell.
Scenario 4: A UE receives a MAC CE with a Cj bit set to 1 for an SCell for which OD-SSB is currently activated. In this scenario also, the UE operation is not straightforward. The UE does not know if it should ignore the Cj bit, is a configuration index included or not included in this case, and if included how to apply this information etc.

Various embodiments of the present disclosure provide mechanisms for proper UE operation in each of the OD-SSB scenarios above.

In some LTM cell switch procedures, SCell(s) are not activated. Instead, SCells can be activated after the LTM cell switch is completed. NW triggering of LTM SCell activation as part of the SpCell LTM cell switch can reduce SCell activation delay. One of the issues to support this is the signaling/mechanism to indicate which SCells are activated when UE receive LTM Cell switch command MAC CE. Various embodiments of the present disclosure provide mechanisms for indicating SCell activation when a UE receives an LTM Cell switch command MAC CE.

As noted above, various embodiments of the present disclosure provide mechanisms for reduced UE energy consumption.

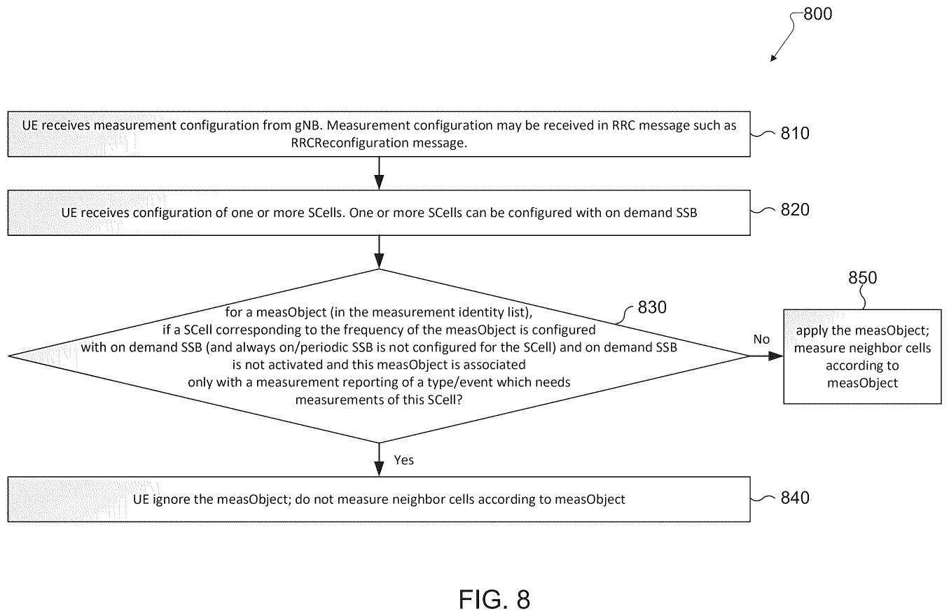

FIG. 8 illustrates an example procedure for neighbor cell measurement 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for neighbor cell measurement could be used without departing from the scope of this disclosure.

In the example of FIG. 8, the procedure 800 begins at operation 810. At operation 810, a UE (such as UE 116 of FIG. 1) receives a measurement configuration from a gNB (such as gNB 102 of FIG. 1). For example, the measurement configuration may be received in an RRC message such as an RRCReconfiguration message.

In some embodiments, the measurement configuration can include a list of one or more measurement objects. Each entry in the list can include a measurement object configuration and measObjectId. Each measurement object can include a frequency, SS/PBCH block measurement timing configuration (SMTC), etc.

In some embodiments, the measurement configuration can include a list of one or more reporting configurations. Each entry in the list can include a reporting configuration and reportConfigId. Each reporting configuration indicates a reporting type and further configuration based on the reporting type (e.g., for event triggered report the reporting type can indicate one of an event such as A1 to A6 and associated parameters for triggering a report).

In some embodiments, the measurement configuration can include a list of one or more measurement identities. Each entry in the list can include measId, the associated measObjectId, and the associated reportConfigId.

At operation 820, the UE receives a configuration of one or more SCells. One or more SCells can be configured with only on demand SSB (i.e., always on/periodic SSB is not configured for the SCell).

In some embodiments, at operation 830, for a measObject (in the measurement identity list), if an SCell corresponding to the frequency of the measObject is configured with on demand SSB (and always on/periodic SSB is not configured for the SCell) and on demand SSB is not activated and this measObject is associated only with a measurement reporting of a type/event which needs measurements of this SCell, then at operation 840 the UE ignores the measObject, and does not measure neighbor cells according to measObject. Otherwise, for a measObject (in the measurement identity list), if an SCell corresponding to the frequency of the measObject is configured with on demand SSB and on demand SSB is activated, then at operation 850 the UE applies the measObject, and measures the neighbor cells according to the measObject.

In some embodiments, at operation 830, for a measObject (in the measurement identity list), if an SCell corresponding to the frequency of the measObject is configured with on demand SSB and on demand SSB is not activated and this measObject is associated with a measurement reporting of a type/event which does not need measurements of this SCell, then at operation 850 the UE applies the measObject, and measures neighbor cells according to measObject.

In some embodiments, at operation 830, for a measObject (in the measurement identity list), if an SCell corresponding to the frequency of the measObject is configured with on demand SSB (and always on/periodic SSB is not configured for the SCell) and on demand SSB is not activated, if the reportType in reportConfig of the measObject is set to eventTriggered (or eventTriggered only) and the associated event is eventA6 (or event A6 only), then at operation 840 the UE ignores the measObject, and does not measure neighbor cells according to measObject. Otherwise (i.e., if the reportType in reportConfig of the measObject is not set to eventTriggered; or if the reportType in reportConfig of the measObject is set to eventTriggered and the associated event is other than eventA6), at operation 850 the UE applies the measObject, and measures neighbor cells according to measObject.

In some embodiments, at operation 830 for a measObject (in the measurement identity list), if an SCell corresponding to the frequency of the measObject is configured with on demand SSB and on demand SSB is activated, then at operation 850 the UE applies the measObject, and applies the measObject; measure neighbor cells according to measObject.

In some embodiments, at operation 830, for a measObject (in the measurement identity list), if an SCell corresponding to the frequency of the measObject is configured with on demand SSB (and always on/periodic SSB is not configured for the SCell) and on demand SSB is not activated, if the measObject is associated with only one reportConfig and this reportConfig is set to eventTriggered (or eventTriggered only) and the associated event is eventA6 (or eventA6 only), then at operation 840 the UE ignores the measObject, and does not measure neighbor cells according to measObject. Otherwise, at operation 850 the UE applies the measObject, and applies the measObject; measure neighbor cells according to measObject.

In some embodiments, at operation 830 for a measObject (in the measurement identity list), if an SCell corresponding to the frequency of the measObject is configured with on demand SSB (and always on/periodic SSB is not configured for the SCell) and on demand SSB is activated, then at operation 850 the UE applies the measObject, and applies the measObject; measure neighbor cells according to measObject.

In some embodiments, at operation 830, for a measObject (in the measurement identity list), if an SCell corresponding to the frequency of the measObject is configured with on demand SSB (and always on/periodic SSB is not configured for the SCell) and on demand SSB is not activated, if all reportConfigs associated with the measObject is set to eventTriggered (or eventTriggered only) and the associated event is eventA6 (or eventA6 only), then at operation 840 the UE ignores the measObject, and does not measure neighbor cells according to measObject. Otherwise, at operation 850 the UE applies the measObject, and applies the measObject; measure neighbor cells according to measObject.

In some embodiments, at operation 830 for a measObject (in the measurement identity list), if an SCell corresponding to the frequency of the measObject is configured with on demand SSB (and always on/periodic SSB is not configured for the SCell) and on demand SSB is activated, then at operation 850 the UE applies the measObject, and applies the measObject; measure neighbor cells according to measObject.

In some embodiments, at operation 830, for each measurement identity included in the list of measurement identities, if the reportType in the associated reportConfig is set to eventTriggered and the associated event is eventA6, and if the associated measObject is not associated with other measurement identity, and if the SCell corresponding to the frequency of the associated measObject is configured with on demand SSB; and periodic/always on SSB is not configured; and on demand SSB is not activated, then at operation 840 the UE the UE ignores the measObject, and does not measure neighbor cells according to measObject.

Although FIG. 8 illustrates one example procedure for neighbor cell measurement 800, various changes may be made to FIG. 8. For example, while shown as a series of operations, various operations in FIG. 8 could overlap, occur in parallel, occur in a different order, occur any number of times, be omitted, or replaced by other operations.

As noted above, various embodiments of the present disclosure provide mechanisms for proper UE operation in various OD-SSB scenarios described herein.

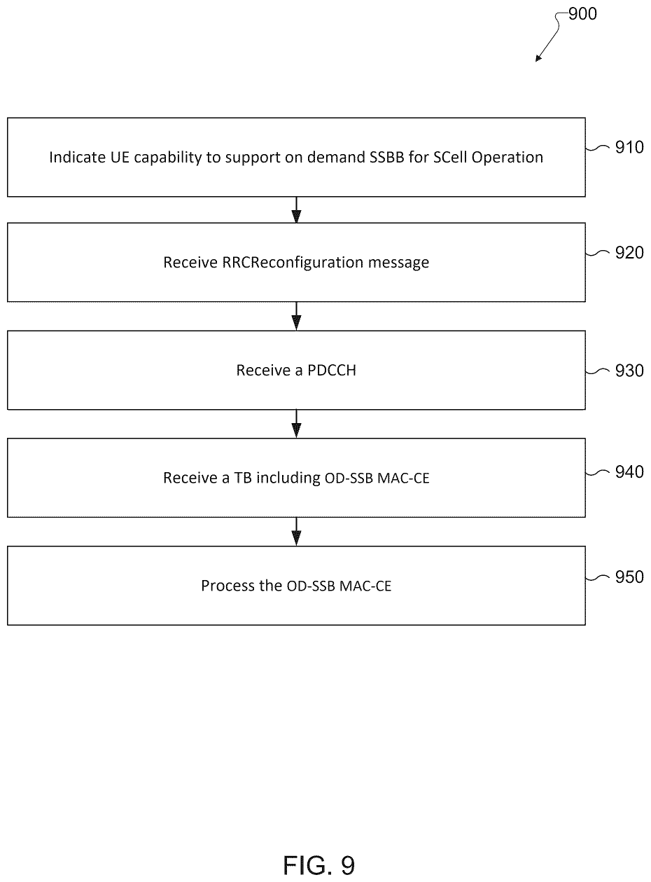

FIG. 9 illustrates an example procedure for SCell on demand SSB transmission 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for SCell on demand SSB transmission could be used without departing from the scope of this disclosure.

In the example of FIG. 9, a UE (such as UE 116 of FIG. 1) is in RRC_CONNECTED state. The procedure 900 begins at operation 910, where the UE indicates its capability to support on demand SSB for SCell operation. In some embodiments, this capability can be a per UE capability, or it can be a per frequency capability or it can be a per frequency band capability or it can be a per frequency range (FR1, FR2-1, FR2-2 and so on) capability.

At operation 920, a gNB (such as gNB 102 of FIG. 1) sends an RRCReconfiguration message, wherein the message includes a configuration of one or more SCells. The message also indicates whether the gNB supports on demand SSB for configured SCell(s). In some embodiments, this indication can be common for all configured SCells or this indication can be per configured SCell. They gNB may indicate support of on demand SSB for zero, one or more configured SCells. For each configured SCell for which the gNB supports on demand SSB, the gNB may provide/signal (e.g., in the RRCReconfiguration message) the configuration (OD-SSB configuration) of on demand SSB transmission. This configuration can be per BWP of the configured SCell or can be common for all BWPs of the configured SCell.

In some embodiments, for OD-SSB configuration, multiple sets of the following parameters can be signaled by RRC, where each set is identified by a configuration index.
od-ssb-Periodicity
od-ssb-sfn-Offset
od-ssb-halfFrameIndex
od-ssb-PositionsInBurst
od-ssb-nrofBurst (optional, present for implicit deactivation).

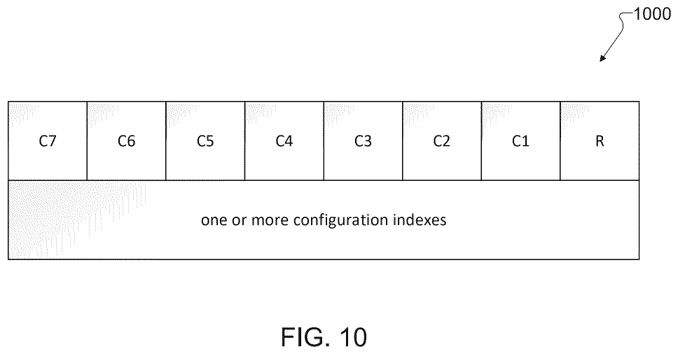

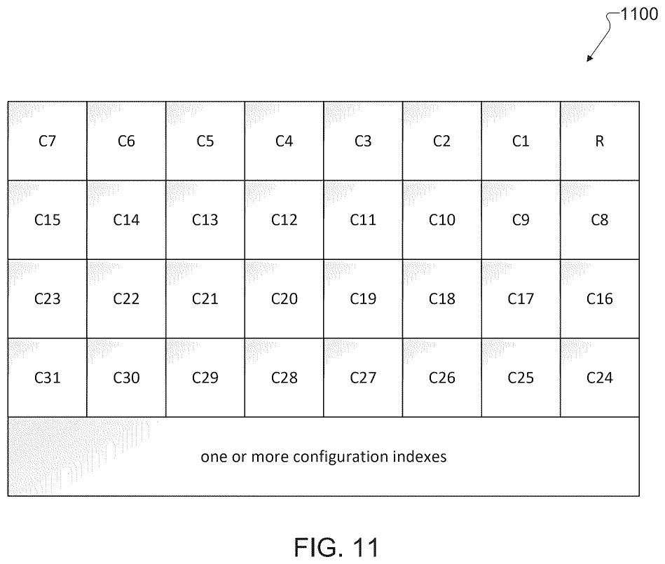

At operation 930, the gNB transmits a PDCCH addressed to a C-RNTI or addressed to an RNTI which can be pre-defined or configured previously in the RRCReconfiguration message. The PDCCH includes scheduling information for a DL TB. At operation 940, the gNB then transmits a TB including a MAC subPDU. The MAC subPDU includes a MAC subheader and MAC CE (OD-SSB MAC-CE). The MAC subheader includes an LCID/eLCID. The LCID/eLCID indicates that the MAC CE in MAC subPDU payload is an OD-SSB MAC-CE that can be pre-defined. Example OD-SSB MAC-CE formats are shown in FIG. 10 and FIG. 11.

FIG. 10 illustrates an example OD-SSB MAC-CE 1000 according to embodiments of the present disclosure. The embodiment of an OD-SSB MAC-CE of FIG. 10 is for illustration only. Different embodiments of an OD-SSB MAC-CE could be used without departing from the scope of this disclosure.

In the example of FIG. 10, the OD-SSB MAC-CE 1000 includes fixed sized bitmap to indicate whether OD-SSB is activated in an SCell via a plurality of Cj fields C1 through C7. A highest ServCellIndex or SCellIndex for which on demand SSB can be indicated by OD-SSB MAC-CE 1000 is less than 8. Each Cj field can be set to 1 or 0. Each Cj field corresponds to an SCell identified by ServCellIndex j.

In some embodiments, OD-SSB MAC-CE 1000 may include one configuration index field corresponding to each Cj bit set to 1. If multiple Cj bits are set to 1, the configuration indexes are included in the MAC CE in ascending order of j for which a Cj bit is set to 1. A Configuration index is not included for an SCell if the corresponding Cj bit for the SCell is set to 0.

Although FIG. 10 illustrates one example OD-SSB MAC-CE 1000, various changes may be made to FIG. 10. For example, various changes to number of Cj fields could be made, etc. according to particular needs.

FIG. 11 illustrates another example OD-SSB MAC-CE 1100 according to embodiments of the present disclosure. The embodiment of an OD-SSB MAC-CE of FIG. 11 is for illustration only. Different embodiments of an OD-SSB MAC-CE could be used without departing from the scope of this disclosure.

In the example of FIG. 11, the OD-SSB MAC-CE 1100 includes fixed sized bitmap to indicate whether OD-SSB is activated in an SCell via a plurality of Cj fields C1 through C31. A highest ServCellIndex or SCellIndex for which on demand SSB can be indicated by OD-SSB MAC-CE 1100 is greater than or equal to 8. Each Cj field can be set to 1 or 0. Each Cj field corresponds to an SCell identified by ServCellIndex j.

In some embodiments, OD-SSB MAC-CE 1100 may include one configuration index field corresponding to each Cj bit set to 1. If multiple Cj bits are set to 1, the configuration indexes are included in the MAC CE in ascending order of j for which a Cj bit is set to 1. A Configuration index is not included for an SCell if the corresponding Cj bit for the SCell is set to 0.

Although FIG. 11 illustrates one example OD-SSB MAC-CE 1100, various changes may be made to FIG. 11. For example, various changes to number of Cj fields could be made, etc. according to particular needs.

At operation 950, the UE processes the OD-SSB MAC-CE according to one or more of the following scenarios 1-4.

In Scenario 1, the UE receives the OD-SSB MAC-CE with a Cj bit set to 0 for an SCell for which OD-SSB is currently deactivated. In this scenario, the UE does not take any action for the SCell with ServCellIndex j. The UE ignores the received Cj bit.

In Scenario 2, the UE receives the OD-SSB MAC-CE with a Cj bit set to 1 for an SCell for which OD-SSB is currently deactivated. In this scenario, the OD-SSB is activated for the SCell with serving cell index j (e.g., ServCellIndex j). The UE identifies the configuration index corresponding to the SCell with ServCellIndex j, amongst the one or more configuration indexes included in the OD-SSB MAC-CE. The UE applies the OD-SSB configuration (received in an RRC message) corresponding to the identified configuration index. In a case where the OD-SSB configuration includes od-ssb-nrofBurst, the UE starts a timer/counter for implicit deactivation.

In scenario 3, the UE receives the OD-SSB MAC-CE with a Cj bit set to 0 for an SCell for which OD-SSB is currently activated. In one embodiment, for scenario 3, the OD-SSB is deactivated for the SCell with ServCellIndex j.

In an alternative embodiment, for scenario 3, if od-ssb-nrofBurst is not included in a configuration applied for the activated OD-SSB (or alternately, if the SCell with ServCellIndex j is not configured with implicit deactivation), then OD-SSB is deactivated for the SCell with ServCellIndex j, and the UE stops the timer/counter for implicit deactivation of OD-SSB if timer/counter was running. If od-ssb-nrofBurst is included in a configuration applied for the activated OD-SSB (or if the SCell with ServCellIndex j is configured with implicit deactivation), then the UE ignores the Cj bit set to 0 (this means explicit deactivation is not supported).

In an alternative embodiment, for scenario 3, if od-ssb-nrofBurst is not included in a configuration applied for the activated OD-SSB (or alternately, if the SCell with ServCellIndex j is not configured with implicit deactivation), then OD-SSB is deactivated for the SCell with ServCellIndex j. If od-ssb-nrofBurst is included in a configuration applied for the activated OD-SSB (or if the SCell with ServCellIndex j is configured with implicit deactivation), if the RRC message indicates that explicit deactivation is supported for the SCell for which implicit deactivation is configured (i.e., od-ssb-nrofBurst is signaled), OD-SSB is deactivated for the SCell with ServCellIndex j, and the UE stops the timer/counter for implicit deactivation of OD-SSB if the timer/counter was running. Otherwise, the UE ignores the Cj bit set to 0 (this means explicit deactivation is not supported).

In scenario 4, the UE receives the OD-SSB MAC-CE with a Cj bit set to 1 for an SCell for which OD-SSB is currently activated. In one embodiment (embodiment SC4-1), for scenario 4, the UE identifies the configuration index corresponding to the SCell with ServCellIndex j amongst the one or more configuration indexes included in the received OD-SSB MAC-CE. If the identified configuration index is different from the configuration index of the configuration applied for the already activated OD-SSB, the UE applies the new configuration based on the identified configuration index received in the OD-SSB MAC-CE. Otherwise, the UE does nothing (i.e., the UE ignores the Cj bit set to 1).

In an alternative embodiment (embodiment SC4-2), for scenario 4, the UE identifies the configuration index corresponding to the SCell with ServCellIndex j amongst the one or more configuration indexes included in the received OD-SSB MAC-CE. If the identified configuration index is different from the configuration index of the configuration applied for the already activated OD-SSB, the UE first deactivates the already activated OD-SSB for the SCell with ServCellIndex j, and the UE stops the timer/counter for implicit deactivation of OD-SSB if timer/counter was running. The UE then activates the OD-SSB for the SCell with ServCellIndex j, and applies the OD-SSB configuration (received in RRC message) corresponding to the identified configuration index. The UE then starts the timer/counter for implicit deactivation if OD-SSB configuration applied includes od-ssb-nrofBurst. Otherwise, if the identified configuration index is not different from the configuration index of the configuration applied for the already activated OD-SSB, the UE does nothing (i.e., the UE ignores the Cj bit set to 1).

In an alternative embodiment (embodiment SC4-3), for scenario 4, the UE identifies the configuration index corresponding to the SCell with ServCellIndex j amongst the one or more configuration indexes included in the received OD-SSB MAC-CE. The UE first deactivates the already activated OD-SSB for the SCell with ServCellIndex j. the UE then activates the OD-SSB for the SCell with ServCellIndex j. The UE applies the OD-SSB configuration (received in RRC message) corresponding to the identified configuration index.

In an alternative embodiment (embodiment SC4-4), for scenario 4, the UE does nothing (i.e., the UE ignores the Cj bit set to 1 in this scenario). In this case even if a Cj bit is set to 1, the configuration index may not be included in the OD-SSB MAC-CE for the SCell with ServCellIndex j if OD-SSB was already activated.

In an alternative embodiment (embodiment SC4-5), for scenario 4, if the RRC message indicates that dynamic change of configuration of activated OD-SSB is not supported, the UE ignores the Cj bit set to 1 in this scenario. In this case even if the Cj bit is set to 1, the configuration index may not be included in the OD-SSB MAC-CE for the SCell with ServCellIndex j if OD-SSB was already activated and RRC message indicates that dynamic change of configuration of activated OD-SSB is not supported. Otherwise, (if the RRC message does not indicate that dynamic change of configuration of activated OD-SSB is not supported) the UE may perform operation as per one of the embodiments SC4-1, SC4-2, or SC4-3.

In an alternative embodiment (embodiment SC4-6), for scenario 4, if implicit activation is applied for activated OD-SSB, the UE ignores the Cj bit set to 1 in this scenario. In this case even if the Cj bit is set to 1, the configuration index may not be included in the OD-SSB MAC-CE for the SCell with ServCellIndex j if OD-SSB was already activated and implicit activation is applied for activated OD-SSB. Otherwise (if implicit activation is not applied for activated OD-SSB), the UE may perform operation as per one of the embodiments SC4-1, SC4-2, or SC4-3.

Although FIG. 9 illustrates one example procedure for SCell on demand SSB transmission 900, various changes may be made to FIG. 9. For example, while shown as a series of operations, various operations in FIG. 9 could overlap, occur in parallel, occur in a different order, occur any number of times, be omitted, or replaced by other operations.

As noted above, various embodiments of the present disclosure provide mechanisms for indicating SCell activation when a UE receives an LTM Cell switch command MAC CE.

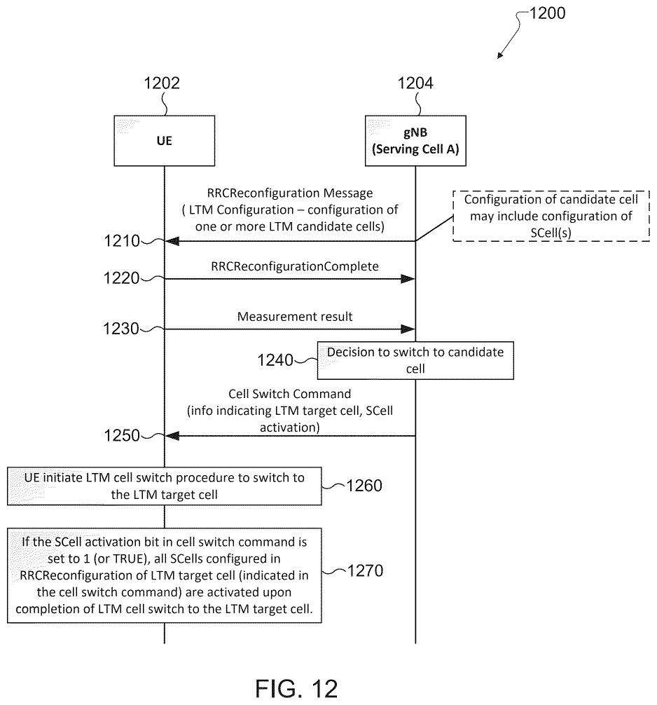

FIG. 12 illustrates an example procedure for lower layer triggered mobility 1200 according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a procedure for lower layer triggered mobility could be used without departing from the scope of this disclosure.

In the example of FIG. 12, the procedure 1200 begins at step 1210. At step 1210, a gNB or base station 1204 of serving cell (“Cell A”) signals an LTM configuration of one or more LTM candidate cells (e.g., “Cell B”, “Cell C”, etc.) in an RRC Reconfiguration message to a UE 1202.

In some embodiments, the LTM configuration of each of the one or more candidate cells includes a configuration of that candidate cell to be applied in a case where an LTM cell switch procedure is executed to that candidate cell. This configuration can be signaled by including an RRCReconfiguration IE for the candidate cell in the LTM configuration. The LTM configuration/RRCReconfiguration IE of the candidate cell may include a configuration of one or more SCells.

In a case where Cell A and a candidate Cell belong to different DUs of the same gNB, the gNB or base station may obtain a configuration of the candidate Cell from the DU of the candidate Cell. In a case where Cell A and the candidate Cell belong to a different DU of different gNBs, the gNB or base station or CU of Cell A may obtain the configuration of the candidate Cell from the gNB or base station or CU of the candidate Cell.

In some embodiments, the LTM configuration of the candidate Cell may include an L1/L3 measurement configuration.

At operation 1220, the UE 1202 confirms the RRC Reconfiguration by transmitting an RRCReconfiguration complete message.

At operation 1230 The UE 1202 provides an L1/L3 measurement report upon performing the measurement based on the L1/L3 measurement configuration.

At operation 1240 the gNB or base station 1204 of Cell A decides to execute cell switch to an LTM candidate cell (e.g., Cell B, also referred to herein as target cell B).

At operation 1250, the gNB or base station 1204 of Cell A transmits a cell switch command (i.e., a MAC CE (or DCI) triggering cell switch) to one of the LTM candidate cells (e.g., Cell B, also referred to herein as LTM target cell B). The Cell switch command indicates the LTM candidate cell (e.g., by including the cell identity or by including the LTM candidate configuration index (or LTM candidate configuration index −1) of the target cell [i.e., Cell B]). At operation 1210, the UE 1202 may receive an LTM configuration of multiple candidate cells and each configuration is identified by a candidate configuration index.

At operation 1260, the UE 1202 switches to the LTM target cell B and applies the configuration indicated by candidate configuration index (or candidate configuration index+1 received in the cell switch command MAC CE) (At step 1210 the UE 1202 may receive an LTM configuration of multiple candidate cells and each configuration is identified by candidate configuration index).

In some embodiments, at operation 1270, the cell switch command may include a 1 bit indication for SCell activation. If the SCell activation bit in cell switch command is set to 1 (or TRUE), all SCells configured in the configuration (e.g., LTM configuration/RRCReconfiguration IE) of the LTM target cell (indicated in the cell switch command) (i.e., Cell B), are activated upon completion of the LTM cell switch to Cell B (or are activated after a time ‘t’ upon completion of LTM cell switch to Cell B where ‘t’ may be configured or pre-defined; or are activated after a time ‘t’ from the reception of cell switch command). For example, assume that Cell 1, Cell 2 and Cell 3 are the SCells configured in the LTM configuration of target cell B. If the SCell activation bit in the cell switch command is set to 1 (or TRUE), Cell 1, Cell 2 and Cell 3 are activated upon completion of the LTM cell switch to Cell B (or are activated after a time ‘t’ upon completion of LTM cell switch to Cell B where ‘t’ may be configured or pre-defined; or are activated after a time ‘t’ from the reception of cell switch command).

Alternatively, in some embodiments, at operation 1270, the cell switch command may include a 1 bit indication for SCell activation. SCells (amongst the SCells configured in LTM configuration (e.g. RRCReconfiguration IE) of LTM target cell) which can be activated by an SCell activation bit in the cell switch command can be indicated in the configuration of the LTM target cell. If the SCell activation bit in the cell switch command is set to 1 (or TRUE), all these SCells are activated upon completion of the LTM cell switch to Cell B (or are activated after a time ‘t’ upon completion of LTM cell switch to Cell B where ‘t’ may be configured or pre-defined; or are activated after a time ‘t’ from the reception of cell switch command). For example, assume that Cell 1, Cell 2 and Cell 3 are the SCells configured in the LTM configuration of target cell B. The LTM configuration of target cell B also indicates that Cell 1 and Cell 3 can be activated by an SCell activation bit in the cell switch command. If the SCell activation bit in the cell switch command is set to 1 (or TRUE), Cell 1 and Cell 3 are activated upon completion of the LTM cell switch to Cell B (or are activated after a time ‘t’ upon completion of LTM cell switch to Cell B where ‘t’ may be configured or pre-defined; or are activated after a time ‘t’ from the reception of cell switch command).

In some embodiments at step 1210, resources may be configured for measurement (L1 or L3) of SCell(s) of the LTM candidate cell. The UE measures and reports them to source cell.

In some embodiments, TCI state(s) for SCell(s) (to be) activated for the LTM candidate/target cell can be included in the MAC CE (e.g., a cell switch command MAC CE, SCell activation/deactivation MAC CE for the LTM candidate/target cell) and this TCI state/TCI states is/are used for that cell after the SCell activation. The TCI state may be separately indicated for each SCell to be activated. In some embodiments, TCI state ID and/or UL TCI state ID fields may be included in the MAC CE (e.g., a cell switch command MAC CE, SCell activation/deactivation MAC CE for the LTM candidate/target cell) for each SCell to be activated. A TCI state ID field for an SCell indicates and activates the TCI state for the SCell. The TCI state is identified by TCI-StateId in a DL or joint TCI state list of the SCell (e.g., ltm-DL-OrJointTCI-StateToAddModList). If the unified TCI state type is joint, the TCI state ID field is for a joint TCI state, otherwise, this field is for a downlink TCI state. A UL TCI state ID field indicates and activates the uplink TCI state for the SCell. The UL TCI state is identified by TCI-UL-StateId in a UL TCI state list of the SCell (e.g. ltm-UL-TCI-StateToAddModList). A UL TCI state ID is included if the unified TCI state type is separate. The unified TCI state type may be included in the TCI configuration of the SCell and is set to joint or separate.

Although FIG. 12 illustrates one example procedure for lower layer triggered mobility 1200, various changes may be made to FIG. 12. For example, while shown as a series of operations, various operations in FIG. 12 could overlap, occur in parallel, occur in a different order, occur any number of times, be omitted, or replaced by other operations.

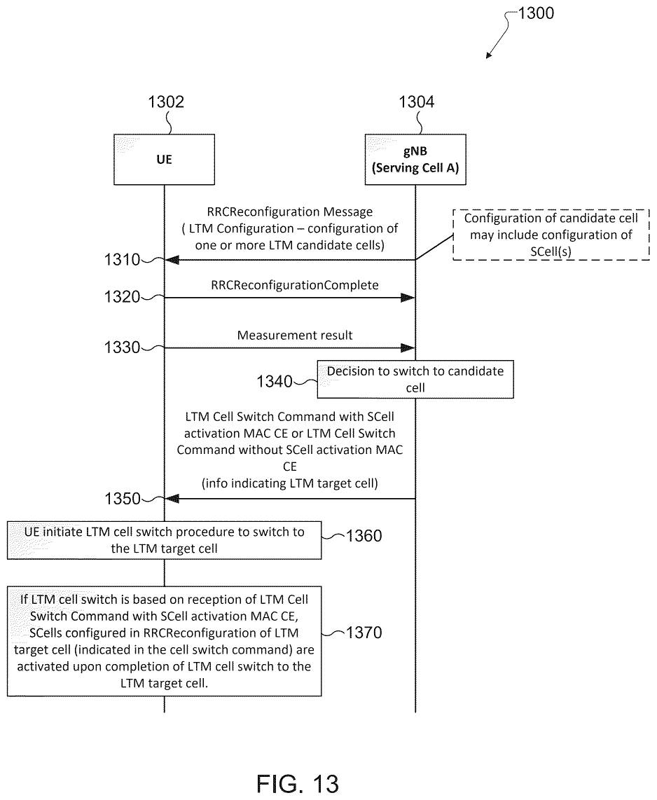

FIG. 13 illustrates another example procedure for lower layer triggered mobility 1300 according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a procedure for lower layer triggered mobility could be used without departing from the scope of this disclosure.

In the example of FIG. 13, the procedure 1300 begins at step 1310. At step 1310, a gNB or base station 1304 of serving cell (“Cell A”) signals an LTM configuration of one or more LTM candidate cells (e.g., “Cell B”, “Cell C”, etc.) in an RRC Reconfiguration message to a UE 1302.

In some embodiments, the LTM configuration of each of the one or more candidate cells includes a configuration of that candidate cell to be applied in a case where an LTM cell switch procedure is executed to that candidate cell. This configuration can be signaled by including an RRCReconfiguration IE for the candidate cell in the LTM configuration. The LTM configuration/RRCReconfiguration IE of the candidate cell may include a configuration of one or more SCells.

In a case where Cell A and a candidate Cell belong to different DUs of the same gNB, the gNB or base station may obtain a configuration of the candidate Cell from the DU of the candidate Cell. In a case where Cell A and the candidate Cell belong to a different DU of different gNBs, the gNB or base station or CU of Cell A may obtain the configuration of the candidate Cell from the gNB or base station or CU of the candidate Cell.

In some embodiments, the LTM configuration of the candidate Cell may include an L1/L3 measurement configuration.

At operation 1320, the UE 1302 confirms the RRC Reconfiguration by transmitting an RRCReconfiguration complete message.

At operation 1330 The UE 1302 provides an L1/L3 measurement report upon performing the measurement based on the L1/L3 measurement configuration.

At operation 1340 the gNB or base station 1304 of Cell A decides to execute cell switch to an LTM candidate cell (e.g., Cell B, also referred to herein as target cell B).

At operation 1350, the gNB or base station 1304 of Cell A transmits one of a) LTM cell switch command without SCell activation MAC CE or b) LTM cell switch command with SCell activation MAC CE, triggering cell switch to one of the LTM candidate cells (e.g., Cell B, also referred to herein as LTM target cell B). Each of the LTM cell switch command MAC CEs indicates the LTM candidate cell (e.g., by including the cell identity or by including the LTM candidate configuration index (or LTM candidate configuration index −1) of the target cell [i.e., Cell B]). At step 1350, UE 1302 may receive an LTM configuration of multiple candidate cells and each configuration is identified by a candidate configuration index. An LTM cell switch command without SCell activation MAC CE and an LTM cell switch command with SCell activation MAC CE uses a different LCID/eLCID in the MAC subheader. An LCID/eLCID for LTM cell switch command without SCell activation MAC CE and an LTM cell switch command with SCell activation MAC CE are pre-defined. In some embodiments, there can be two LTM cell switch command with SCell activation MAC CEs, one for LTM cell switch with security key change (including NCC in the MAC CE) and another for LTM cell switch without security key change (not including NCC in the MAC CE).

At operation 1360, the UE 1302 switches to the LTM target cell B and applies the configuration indicated by candidate configuration index (or candidate configuration index+1 received in the cell switch command MAC CE) (At step 1310 the UE 1302 may receive an LTM configuration of multiple candidate cells and each configuration is identified by candidate configuration index).

In some embodiments, at operation 1370, if the cell switch command MAC CE received for the LTM cell switch is the LTM cell switch command with SCell activation MAC CE, all SCells configured in the configuration (e.g., RRCReconfiguration IE) of the LTM target cell (indicated in the cell switch command) (i.e., Cell B) are activated upon completion of the LTM cell switch to Cell B (or are activated after a time ‘t’ upon completion of LTM cell switch to Cell B where ‘t’ may be configured or pre-defined; or are activated after a time ‘t’ from the reception of cell switch command). For example, assume Cell 1, Cell 2 and Cell 3 are the SCells configured in the LTM configuration of target cell B. If the cell switch command MAC CE received for LTM cell switch is the LTM cell switch command with SCell activation MAC CE, Cell 1, Cell 2 and Cell 3 are activated upon completion of the LTM cell switch to Cell B (or are activated after a time ‘t’ upon completion of LTM cell switch to Cell B where ‘t’ may be configured or pre-defined; or are activated after a time ‘t’ from the reception of cell switch command). In some embodiments, TCI state(s) for SCell(s) (to be) activated for the LTM candidate/target cell can be included in the LTM cell switch command with SCell activation MAC CE and this TCI state/TCI states is/are used for that cell after the SCell activation. The TCI state may be separately indicated for each SCell to be activated. In some embodiments, TCI state ID and/or UL TCI state ID fields may be included in the MAC CE (e.g., a cell switch command MAC CE, SCell activation/deactivation MAC CE for LTM candidate/target cell) for each SCell to be activated. A TCI state ID field for an SCell indicates and activates the TCI state for the SCell. The TCI state is identified by TCI-StateId in a DL or joint TCI state list of the SCell (e.g., ltm-DL-OrJointTCI-StateToAddModList). If the unified TCI state type is joint, the TCI state ID field is for a joint TCI state, otherwise, this field is for a downlink TCI state. A UL TCI state ID field indicates and activates the uplink TCI state for the SCell. The UL TCI state is identified by TCI-UL-StateId in a UL TCI state list of the SCell (e.g., ltm-UL-TCI-StateToAddModList). A UL TCI state ID is included if the unified TCI state type is separate. The unified TCI state type may be included in the TCI configuration of the SCell and is set to joint or seperate.

Alternatively, in some embodiments, at operation 1370, SCells (amongst the SCells configured in the LTM configuration (e.g., RRCReconfiguration IE) of LTM target cell) which can be activated by the LTM cell switch command with SCell activation MAC CE can be indicated in the configuration of the LTM target cell. If the cell switch command MAC CE received for the LTM cell switch is the LTM cell switch command with SCell activation MAC CE, all these SCells are activated upon completion of LTM cell switch to Cell B (or are activated after a time ‘t’ upon completion of LTM cell switch to Cell B where ‘t’ may be configured or pre-defined; or are activated after a time ‘t’ from the reception of cell switch command). For example, assume that Cell 1, Cell 2 and Cell 3 are the SCells configured in the LTM configuration of target cell B. the LTM configuration of target cell B also indicates that Cell 1 and Cell 3 can be activated by the LTM cell switch command with the SCell activation MAC CE. If the cell switch command MAC CE received for the LTM cell switch is the LTM cell switch command with SCell activation MAC CE, Cell 1 and Cell 3 are activated upon completion of the LTM cell switch to Cell B (or are activated after a time ‘t’ upon completion of LTM cell switch to Cell B where ‘t’ may be configured or pre-defined; or are activated after a time ‘t’ from the reception of cell switch command). In some embodiments, TCI state(s) for SCell(s) (to be) activated for the LTM candidate/target cell can be included in this LTM cell switch command with SCell activation MAC CE and this TCI state/TCI states is/are used for that cell after the SCell activation. The TCI state may be separately indicated for each SCell to be activated. In some embodiments, TCI state ID and/or UL TCI state ID fields may be included in the MAC CE (e.g., a cell switch command MAC CE, SCell activation/deactivation MAC CE for LTM candidate/target cell) for each SCell to be activated. A TCI state ID field for an SCell indicates and activates the TCI state for the SCell. The TCI state is identified by TCI-StateId in a DL or joint TCI state list of the SCell (e.g., ltm-DL-OrJointTCI-StateToAddModList). If the unified TCI state type is joint, the TCI state ID field is for a joint TCI state, otherwise, this field is for a downlink TCI state. A UL TCI state ID field indicates and activates the uplink TCI state for the SCell. The UL TCI state is identified by TCI-UL-StateId in a UL TCI state list of the SCell (e.g., ltm-UL-TCI-StateToAddModList)/A UL TCI state ID is included if the unified TCI state type is separate. The unified TCI state type may be included in the TCI configuration of the SCell is set to joint or seperate. In some embodiments, an SCell (de) activation bitmap may be included in an LTM Cell switch command MAC CE. If the UE 1302 receives an LTM Cell switch command MAC CE with SCell (de) activation bitmap, and if the bit corresponding to the SCell configured in the configuration of the LTM target cell is set to 1, the SCell is activated upon completion of the LTM cell switch to Cell B (or are activated after a time ‘t’ upon completion of LTM cell switch to Cell B where ‘t’ may be configured or pre-defined; or are activated after a time ‘t’ from the reception of cell switch command). In some embodiments, a 1 bit in an LTM Cell switch command MAC CE may indicate presence/absence of an SCell (de) activation bitmap in the LTM Cell switch command MAC CE; or a 1 bit in the LTM configuration indicates presence/absence of an SCell (de) activation bitmap in LTM Cell switch command MAC CE; or if a configuration (RRCReconfiguration) of the LTM target cell includes configuration of SCell(s), an SCell (de) activation bitmap is present in the LTM Cell switch command MAC CE; or if an LCID/eLCID for LTM Cell switch command MAC CE for SCell activation is included in the MAC subheader, an SCell (de) activation bitmap is present in the LTM Cell switch command MAC CE. In some embodiments, a size of the bit map can be fixed to 4 octets (32 bits) wherein there is one to one mapping between SCellIndex and bit in bitmap. In some embodiments, a size of the bitmap can be 1 octet or 4 octets (32 bits) depending on highest SCellIndex of SCell included in RRCReconfiguration of LTM target cell. A size of the bitmap is 4 octets if a highest SCellIndex is greater than 7. Otherwise there is 1 octet (8 bits), one to one mapping between the SCellIndex and bits in the bitmap. In some embodiments, the size of bitmap can be 1 or 2 or 3 or 4 octets. The size is determined based on the number of SCells configured. In these embodiments, the size is not based on a highest SCellIndex. If the number of SCells configured is less than 8, the size of bitmap is 1 octet. If the number of SCells configured is less than 16 and a greater than 7, the size of the bitmap is 2 octets. If the number of SCells configured less than 24 and greater than 15, the size of bitmap is 3 octets. If the number of SCells configured less than 32 and greater than 23, the size of the bitmap is 4 octets. In some embodiments, TCI state(s) for SCell(s) (to be) activated for the LTM candidate/target cell can be included in this LTM cell switch command MAC CE and this TCI state/TCI states is/are used for that cell after the SCell activation. The TCI state may be separately indicated for each SCell to be activated. In some embodiments, TCI state ID and/or UL TCI state ID fields may be included in the MAC CE (e.g., a cell switch command MAC CE, SCell activation/deactivation MAC CE for LTM candidate/target cell) for each SCell to be activated. A TCI state ID field for an SCell indicates and activates the TCI state for the SCell. The TCI state is identified by TCI-StateId in a DL or joint TCI state list of the SCell (e.g., ltm-DL-OrJointTCI-StateToAddModList). If the unified TCI state type is joint, the TCI state ID field is for a joint TCI state, otherwise, this field is for a downlink TCI state. A UL TCI state ID field indicates and activates the uplink TCI state for the SCell. The UL TCI state is identified by TCI-UL-StateId in a UL TCI state list of the SCell (e.g., ltm-UL-TCI-StateToAddModList). A UL TCI state ID is included if the unified TCI state type is separate. The unified TCI state type may be included in the TCI configuration of the SCell and is set to joint or seperate.

In some embodiments, one or more SCellIndex (s) are included in the LTM Cell switch command MAC CE. If the UE 1302 receives the LTM Cell switch command MAC CE with one or more SCellIndex (s), SCell(s) corresponding to the included SCellIndex(s) are activated upon completion of the LTM cell switch to Cell B (or are activated after a time ‘t’ upon completion of LTM cell switch to Cell B where ‘t’ may be configured or pre-defined; or are activated after a time ‘t’ from the reception of cell switch command). 1 bit in the LTM Cell switch command MAC CE indicates presence/absence of SCellIndex(s) in the LTM Cell switch command MAC CE; or 1 bit in the LTM configuration indicates presence/absence of SCellIndex(s) in the LTM Cell switch command MAC CE; or if a configuration (RRCReconfiguration) of the LTM target cell includes a configuration of SCell(s), SCellIndex(s) are present in the LTM Cell switch command MAC CE; or If an LCID/eLCID for the LTM Cell switch command MAC CE for SCell activation is included in the MAC subheader, SCellIndex(s) are present in the LTM Cell switch command MAC CE and may include the number of SCells activated. In some embodiments, TCI state(s) for SCell(s) (to be) activated for the LTM candidate/target cell can be included in this LTM cell switch command MAC CE and this TCI state/TCI states is/are used for that cell after the SCell activation. The TCI state may be separately indicated for each SCell to be activated. In some embodiments, TCI state ID and/or UL TCI state ID fields may be included in the MAC CE (e.g., a cell switch command MAC CE, SCell activation/deactivation MAC CE for LTM candidate/target cell) for each SCell to be activated. A TCI state ID field for an SCell indicates and activates the TCI state for the SCell. The TCI state is identified by TCI-StateId in a DL or joint TCI state list of the SCell (e.g., ltm-DL-OrJointTCI-StateToAddModList). If the unified TCI state type is joint, the TCI state ID field is for a joint TCI state, otherwise, this field is for a downlink TCI state. A UL TCI state ID field indicates and activates the uplink TCI state for the SCell. The UL TCI state is identified by TCI-UL-StateId in a UL TCI state list of the SCell (e.g. ltm-UL-TCI-StateToAddModList). A UL TCI state ID is included if the unified TCI state type is separate. The unified TCI state type may be included in the TCI configuration of the SCell and is set to joint or seperate.

In some embodiments, a new SCell Activation/Deactivation MAC CE is defined. The MAC CE includes a bitmap of SCells to be (de)activated. This MAC CE has the same content as existing SCell Activation/Deactivation MAC CEs, but uses a different LCID/eLCID in the MAC subheader. For SCell activation with LTM cell switch, this new MAC CE is included in a MAC PDU together with an LTM Cell switch command MAC CE. The UE 1302 applies this new MAC CE to determine the SCells to be activated for the target cell indicated in LTM Cell switch command MAC CE. The UE 1302 receives the MAC PDU including the new SCell Activation/Deactivation MAC CE and LTM Cell switch command MAC CE. Each SCell (configured in the LTM configuration of the target cell [i.e., Cell B]) for which the corresponding bit in the SCell Activation/Deactivation MAC CE is set to 1 is activated upon completion of the LTM cell switch to Cell B (or are activated after a time ‘t’ upon completion of LTM cell switch to Cell B where ‘t’ may be configured or pre-defined; or are activated after a time ‘t’ from the reception of cell switch command). In some embodiments, TCI state(s) for SCell(s) (to be) activated for the LTM candidate/target cell can be included in this new SCell Activation/Deactivation MAC CE and this TCI state/TCI states is/are used for that cell after the SCell activation. The TCI state may be separately indicated for each SCell to be activated. In some embodiments, TCI state ID and/or UL TCI state ID fields may be included in the MAC CE (e.g., a cell switch command MAC CE, SCell activation/deactivation MAC CE for LTM candidate/target cell) for each SCell to be activated. A TCI state ID field for an SCell indicates and activates the TCI state for the SCell. The TCI state is identified by TCI-StateId in a DL or joint TCI state list of the SCell (e.g., ltm-DL-OrJointTCI-StateToAddModList). If the unified TCI state type isjoint, the TCI state ID field is for joint TCI state, otherwise, this field is for downlink TCI state. A UL TCI state ID field indicates and activates the uplink TCI state for the SCell. The UL TCI state is identified by TCI-UL-StateId in a UL TCI state list of the SCell (e.g. ltm-UL-TCI-StateToAddModList). A UL TCI state ID is included if the unified TCI state type is separate. The unified TCI state type may be included in the TCI configuration of the SCell and is set to joint or seperate.

In some embodiment, an SCell Activation/Deactivation MAC CE is included in the MAC PDU together with the LTM Cell switch command MAC CE. The UE 1302 applies this SCell Activation/Deactivation MAC CE to determine the SCells to be activated for the target cell indicated in the LTM Cell switch command MAC CE. The SCell Activation/Deactivation MAC CE may be included after the LTM Cell switch command MAC CE in the MAC PDU. The UE 1302 receives the MAC PDU including the SCell Activation/Deactivation MAC CE and LTM Cell switch command MAC CE. Each SCell (configured in the LTM configuration of target cell i.e., Cell B) for which the corresponding bit in the SCell Activation/Deactivation MAC CE is set to 1 is activated upon completion of LTM cell switch to Cell B (or are activated after a time ‘t’ upon completion of LTM cell switch to Cell B where ‘t’ may be configured or pre-defined; or are activated after a time ‘t’ from the reception of cell switch command).

In some embodiments, the MAC PDU containing the LTM cell switch command MAC CE also include a SCell Activation/Deactivation MAC CE in cases where:
1 bit in the LTM Cell switch command MAC CE indicates SCell activation; or
1 bit in the LTM configuration indicates SCell activation; or
if an RRCReconfiguration of the LTM target cell includes a configuration of SCell(s); or
If a new LCID/eLCID is included in the MAC subheader for the LTM Cell switch command MAC CE.

In some embodiments, if the LTM cell switch command MAC CE is received, all SCells configured in a configuration (e.g., RRCReconfiguration IE) of the LTM target cell (indicated in the cell switch command) (i.e., Cell B) and for which sCellState (or alternately sCellStateLTM) in the configuration is ‘activated’, are activated upon completion of LTM cell switch to Cell B (or are activated after a time ‘t’ upon completion of LTM cell switch to Cell B where ‘t’ may be configured or pre-defined; or are activated after a time ‘t’ from the reception of cell switch command). For example, assume that Cell 1, Cell 2 and Cell 3 are the SCells configured in the LTM configuration of target cell B. sCellState (or alternately sCellStateLTM) of Cell 1 and Cell 3 is ‘activated’. If the LTM cell switch command MAC CE is received, Cell 1 and Cell 3 are activated upon completion of the LTM cell switch to Cell B (or are activated after a time ‘t’ upon completion of LTM cell switch to Cell B where ‘t’ may be configured or pre-defined; or are activated after a time ‘t’ from the reception of cell switch command). In some embodiments, TCI state(s) for SCell(s) (to be) activated for the LTM candidate/target cell can be included in the cell switch command MAC CE and this TCI state/TCI states is/are used for that cell after the SCell activation. The TCI state may be separately indicated for each SCell to be activated. In some embodiments, TCI state ID and/or UL TCI state ID fields may be included in the MAC CE (e.g., a cell switch command MAC CE, SCell activation/deactivation MAC CE for LTM candidate/target cell) for each SCell to be activated. A TCI state ID field for an SCell indicates and activates the TCI state for the SCell. The TCI state is identified by TCI-StateId in a DL or joint TCI state list of the SCell (e.g., ltm-DL-OrJointTCI-StateToAddModList). If the unified TCI state type is joint, the TCI state ID field is for a joint TCI state, otherwise, this field is for downlink TCI state. A UL TCI state ID field indicates and activates the uplink TCI state for the SCell. The UL TCI state is identified by TCI-UL-StateId in a UL TCI state list of the SCell (e.g., ltm-UL-TCI-StateToAddModList). A UL TCI state ID is included if the unified TCI state type is separate. the unified TCI state type may be included in the TCI configuration of the SCell and is set to joint or seperate.

In some embodiments, for intra CU LTM cell switch, a source DU may inform a CU about a cell switch decision. The CU may then inform about SCells to be activated to a DU which then sends a cell switch command and information about the SCell to be activated to the UE 1302.

In some embodiments, a new SCell Activation/Deactivation MAC CE is defined. The SCell Activation/Deactivation MAC CE may include a bitmap where each bit in the bitmap corresponds to an SCell in an LTM candidate configuration or for an LTM candidate cell. A bit corresponding to an SCell can be set to 1 to indicate that the SCell needs to be activated. Alternately, the SCell Activation/Deactivation MAC CE may include an SCell index of SCells to be activated for an LTM candidate cell/LTM candidate configuration. A candidate/target configuration index may be included in the MAC CE to identify the LTM candidate cell/LTM candidate configuration. If the candidate configuration index of an LTM candidate cell/LTM candidate configuration is X, X may be included in a MAC CE or X−1 may be included in the MAC CE. A UE determines the SCells to be activated for the LTM target cell indicated in LTM Cell switch command MAC CE based on the SCell Activation/Deactivation MAC CE received for the LTM target cell. An LCID/eLCID in the MAC subheader SCell Activation/Deactivation MAC CE for the LTM candidate cell can be different from an existing SCell Activation/Deactivation MAC CE. In some embodiments, a new SCell Activation/Deactivation MAC CE may indicate SCells to be activated for multiple LTM candidate cells/LTM candidate configurations.

In some embodiments, A UE first receives a MAC PDU including a new SCell Activation/Deactivation MAC CE for an LTM candidate cell/LTM candidate configuration. The MAC PDU is received from a source cell/serving cell. The UE later receives another MAC PDU including an LTM Cell switch command MAC CE. The MAC PDU is received from the source cell/serving cell. Each SCell (configured in the LTM configuration of the target cell [i.e., Cell B]) for which the corresponding bit in the SCell Activation/Deactivation MAC CE is set to 1 or whose SCell index is included in the SCell Activation/Deactivation MAC CE, is activated upon completion of the LTM cell switch to Cell B (or are activated after a time ‘t’ upon completion of the LTM cell switch to Cell B where ‘t’ may be configured or pre-defined; or are activated after a time ‘t’ from the reception of the cell switch command or are activated upon reception of an LTM Cell switch command MAC CE).

Alternatively, in some embodiments, A UE first receives a MAC PDU including a new SCell Activation/Deactivation MAC CE for an LTM candidate cell/LTM candidate configuration, the MAC PDU is received from a source cell/serving cell. After receiving the PDU, criteria for a conditional LTM cell switch to an LTM candidate cell (i.e., Cell B) is met. Each SCell (configured in the LTM configuration of the target cell [i.e., Cell B]) for which the corresponding bit in the SCell Activation/Deactivation MAC CE is set to 1 or whose SCell index is included in the SCell Activation/Deactivation MAC CE, is activated upon completion of the LTM cell switch to Cell B (or are activated after a time ‘t’ upon completion of the LTM cell switch to Cell B where ‘t’ may be configured or pre-defined; or are activated after a time ‘t’ from the reception of the cell switch command or are activated upon reception of an LTM Cell switch command MAC CE).

In some embodiments, TCI state(s) for SCell(s) (to be) activated for the LTM candidate/target cell can be included in the new SCell Activation/Deactivation MAC CE for the LTM candidate cell/LTM candidate configuration and this TCI state/TCI states is/are used for that cell after the SCell activation. The TCI state may be separately indicated for each SCell to be activated. In some embodiments, TCI state ID and/or UL TCI state ID fields may be included in the MAC CE (e.g., a cell switch command MAC CE, SCell activation/deactivation MAC CE for LTM candidate/target cell) for each SCell to be activated. A TCI state ID field for an SCell indicates and activates the TCI state for the SCell. The TCI state is identified by TCI-StateId in a DL or joint TCI state list of the SCell (e.g., ltm-DL-OrJointTCI-StateToAddModList). If the unified TCI state type is joint, the TCI state ID field is for a joint TCI state, otherwise, this field is for a downlink TCI state. A UL TCI state ID field indicates and activates the uplink TCI state for the for the SCell. The UL TCI state is identified by TCI-UL-StateId in a UL TCI state list of the SCell (e.g., ltm-UL-TCI-StateToAddModList). A UL TCI state ID is included if the unified TCI state type is separate. The unified TCI state type may be included in the TCI configuration of the SCell and is set to joint or seperate.

In some embodiments, for an intra CU LTM cell switch, a source DU may inform its CU about a cell switch decision. The CU may then inform about SCells to be activated to the DU which then sends a cell switch command and information about the SCell to be activated to the UE. Alternatively, in some embodiments, the DU decides the target cell's SCell activation/deactivation, and SCells to be activated. The DU then informs them to the CU.

In some embodiments, for inter CU LTM cell switch, a source DU may inform a source CU about a cell switch decision. The Source CU informs the target CU about the cell switch decision. The target CU may then inform about SCells to be activated to the source CU. The source CU may then inform about SCells to be activated to the source DU which then sends a cell switch command and information about the SCell to be activated to the UE 1302. The source CU may forward the SCell measurements to the target CU. Alternatively, the source CU can decide the SCells to be activated and inform the target CU.

In some embodiments, UE 1302 may indicate its capability to support SCell activation with LTM cell switch. The Capability can be per UE or per frequency range (FR1, FR2, etc.) or per frequency.

In some embodiments, resources may be configured for measurement (L1 or L3) of SCell(s) of LTM candidate cells. UE 1302 measures and reports them to the source cell. In some embodiments, TCI state(s) for SCell(s) (to be) activated for the LTM candidate/target cell can be included in the cell switch command MAC CE and this TCI state/TCI states is/are used for that cell after the SCell activation. The TCI state may be separately indicated for each SCell to be activated. In some embodiments, TCI state ID and/or UL TCI state ID fields may be included in the MAC CE (e.g., a cell switch command MAC CE, SCell activation/deactivation MAC CE for LTM candidate/target cell) for each SCell to be activated. A TCI state ID field for an SCell indicates and activates the TCI state for the SCell. The TCI state is identified by TCI-StateId in a DL or joint TCI state list of the SCell (e.g., ltm-DL-OrJointTCI-StateToAddModList). If the unified TCI state type is joint, the TCI state ID field is for a joint TCI state, otherwise, this field is for downlink TCI state. A UL TCI state ID field indicates and activates the uplink TCI state for the SCell. The UL TCI state is identified by TCI-UL-StateId in a UL TCI state list of the SCell (e.g., ltm-UL-TCI-StateToAddModList). A UL TCI state ID is included if the unified TCI state type is separate. The unified TCI state type may be included in the TCI configuration of the SCell.

Although FIG. 13 illustrates one example procedure for lower layer triggered mobility 1300, various changes may be made to FIG. 13. For example, while shown as a series of operations, various operations in FIG. 13 could overlap, occur in parallel, occur in a different order, occur any number of times, be omitted, or replaced by other operations.

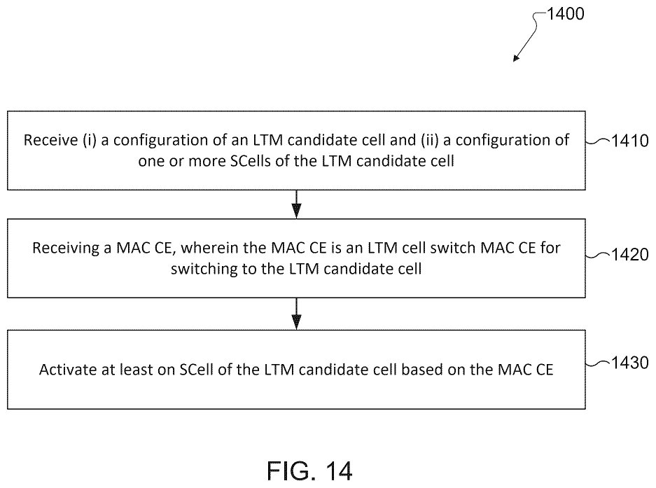

FIG. 14 illustrates an example method for mobility with secondary cell activation 1400 according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for mobility with secondary cell activation could be used without departing from the scope of this disclosure.

In the example of FIG. 14, the method 1400 begins at step 1410. At step 1410, a UE (such as UE 116, 1202, or 1302) receives (i) a configuration of an LTM candidate cell and (ii) a configuration of one or more SCells of the LTM candidate cell.

At step 1420, the UE receives a MAC CE. The MAC CE is an LTM cell switch MAC CE for switching to the LTM candidate cell.

At step 1430, the UE activates at least one SCell of the LTM candidate cell based on the MAC CE.

In some embodiments, activating the at least one SCell of the LTM candidate cell based on the MAC CE comprises (i) receiving an SCell activation bit in the MAC CE, (ii) determining that the SCell activation bit is set to 1, and (iii) in response to the determination that the SCell activation bit is set to 1, activating all configured SCells of the LTM candidate cell.

In some embodiments, activating the at least one SCell of the LTM candidate cell based on the MAC CE comprises determining that the MAC CE is an LTM cell switch command with SCell activation MAC CE, and in response to the determination that the MAC CE is an LTM cell switch command with SCell activation MAC CE, activating all configured SCells of the LTM candidate cell.

In some embodiments, activating the at least one SCell of the LTM candidate cell based on the MAC CE comprises (i) receiving a plurality of SCell activation bits in the MAC CE, each SCell activation bit corresponding with an SCell of the LTM candidate cell, (ii) determining that at least one of the plurality of SCell activation bits is set to 1, and (iii) in response to the determination that the at least one of the plurality of SCell activation bits is set to 1, activating each of the SCells of the LTM candidate cell corresponding with the SCell activations bits set to 1.

In some embodiments, activating the at least one SCell of the LTM candidate cell based on the MAC CE comprises receiving an identity of one or more SCells of the LTM candidate cells in the MAC CE, and activating the one or more SCells of the LTM candidate cell whose identity is included in the MAC CE.

In some embodiments, activating the at least one SCell of the LTM candidate cell based on the MAC CE comprises determining that an sCellState parameter in the configuration of the one or more SCells is set to active, and in response to the determination that the sCellState parameter in the configuration of the one or more SCells is set to active, activating, for each of the sCellState parameters set to active, a corresponding SCell.

In some embodiments, one or more SCells of the LTM candidate cell are activated upon completion of an LTM cell switch.

In some embodiments, one or more SCells of the LTM candidate cell are activated at a time ‘t’ after completion of an LTM cell, and the time ‘t’ is one of a configured time or a pre-defined time.

In some embodiments, one or more SCells of the LTM candidate cell are activated at a time ‘t’ after reception of the MAC CE.

In some embodiments, the MAC CE includes a transmission configuration indicator (TCI) state for the at least one SCell of the LTM candidate cell to be activated, and the TCI state for the at least one SCell of the LTM candidate cell is used for that SCell after activation of that SCell.

Although FIG. 14 illustrates one example method for mobility with secondary cell activation 1400, various changes may be made to FIG. 14. For example, while shown as a series of steps, various steps in FIG. 14 could overlap, occur in parallel, occur in a different order, occur any number of times, be omitted, or replaced by other steps.

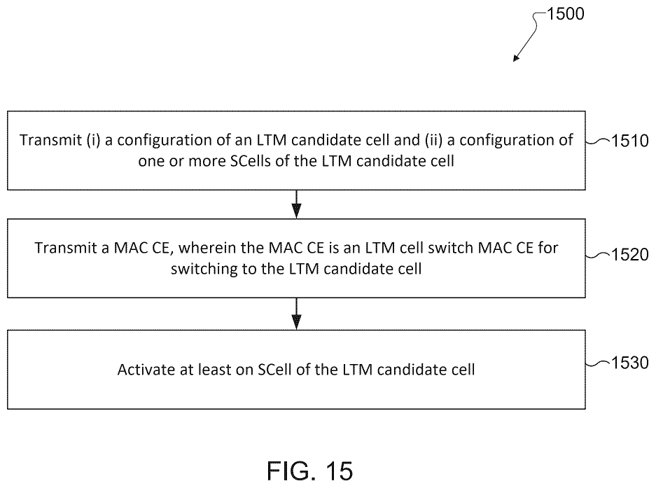

FIG. 15 illustrates another example method for mobility with secondary cell activation 1500 according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a method for mobility with secondary cell activation could be used without departing from the scope of this disclosure.

In the example of FIG. 15, the method 1500 begins at step 1510. At step 1510, a BS (such as gNB 102, 1204, or 1304) transmits (i) a configuration of an LTM candidate cell and (ii) a configuration of one or more SCells of the LTM candidate cell.

At step 1520, the BS transmits a MAC CE. The MAC CE is an LTM cell switch MAC CE for switching to the LTM candidate cell.

At step 1530, the BS activates at least one SCell of the LTM candidate cell.

In some embodiments, activating the at least one SCell of the LTM candidate cell comprises transmitting an SCell activation bit in the MAC CE, and the SCell activation being set to 1 instructs a UE to activate all configured SCells of the LTM candidate cell.

In some embodiments, activating the at least one SCell of the LTM candidate cell comprises transmitting the MAC CE as an LTM cell switch command with SCell activation MAC CE, and the LTM cell switch command with SCell activation MAC CE instructs a UE to activate all configured SCells of the LTM candidate cell.

In some embodiments, activating the at least one SCell of the LTM candidate cell comprises transmitting a plurality of SCell activation bits in the MAC CE, each SCell activation bit corresponding with an SCell of the LTM candidate cell, and the SCell activation bits being set to 1 instructs a UE to activate each of the SCells of the LTM candidate cell corresponding with the SCell activations bits set to 1.

In some embodiments, activating the at least one SCell of the LTM candidate cell comprises transmitting an identity of one or more SCells of the LTM candidate cells in the MAC CE, and the MAC CE instructs a UE to activate the one or more SCells of the LTM candidate cell whose identity is included in the MAC CE.

In some embodiments, activating the at least one SCell of the LTM candidate cell comprises setting an sCellState parameter in the configuration of the one or more SCells to active, and the MAC CE instructs a UE to activate, for each of the sCellState parameters set to active, a corresponding SCell.

In some embodiments, one or more SCells of the LTM candidate cell are activated upon completion of an LTM cell switch.

In some embodiments, one or more SCells of the LTM candidate cell are activated at a time ‘t’ after completion of an LTM cell, and the time ‘t’ is one of a configured time or a pre-defined time.

In some embodiments, one or more SCells of the LTM candidate cell are activated at a time ‘t’ after reception of the MAC CE.

In some embodiments, the MAC CE includes a transmission configuration indicator (TCI) state for the at least one SCell of the LTM candidate cell to be activated, and the TCI state for the at least one SCell of the LTM candidate cell is used for that SCell after activation of that SCell.

Although FIG. 15 illustrates one example method for mobility with secondary cell activation 1500, various changes may be made to FIG. 15. For example, while shown as a series of steps, various steps in FIG. 15 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
receiving (i) a configuration of a layer 1 (L1)/layer 2 (L2) triggered mobility (LTM) candidate cell and (ii) a configuration of one or more secondary cells (SCells) of the LTM candidate cell;
receiving a medium access control (MAC) control element (CE), wherein the MAC CE is an LTM cell switch MAC CE for switching to the LTM candidate cell; and
activating at least one SCell of the LTM candidate cell based on the MAC CE.

2. The method of claim 1, wherein activating the at least one SCell of the LTM candidate cell based on the MAC CE comprises:
receiving an SCell activation bit in the MAC CE;
determining that the SCell activation bit is set to 1; and
in response to the determination that the SCell activation bit is set to 1, activating all configured SCells of the LTM candidate cell.

3. The method of claim 1, wherein activating the at least one SCell of the LTM candidate cell based on the MAC CE comprises:
determining that the MAC CE is an LTM cell switch command with SCell activation MAC CE; and
in response to the determination that the MAC CE is an LTM cell switch command with SCell activation MAC CE, activating all configured SCells of the LTM candidate cell.

4. The method of claim 1, wherein activating the at least one SCell of the LTM candidate cell based on the MAC CE comprises:
receiving a plurality of SCell activation bits in the MAC CE, each SCell activation bit corresponding with an SCell of the LTM candidate cell;
determining that at least one of the plurality of SCell activation bits is set to 1; and
in response to the determination that the at least one of the plurality of SCell activation bits is set to 1, activating each of the SCells of the LTM candidate cell corresponding with the SCell activations bits set to 1.

5. The method of claim 1, wherein activating the at least one SCell of the LTM candidate cell based on the MAC CE comprises:
receiving an identity of one or more SCells of the LTM candidate cells in the MAC CE; and
activating the one or more SCells of the LTM candidate cell whose identity is included in the MAC CE.

6. The method of claim 1, wherein activating the at least one SCell of the LTM candidate cell based on the MAC CE comprises:
determining that an sCellState parameter in the configuration of the one or more SCells is set to active; and
in response to the determination that the sCellState parameter in the configuration of the one or more SCells is set to active, activating, for each of the sCellState parameters set to active, a corresponding SCell.

7. The method of claim 1, wherein one or more SCells of the LTM candidate cell are activated upon completion of an LTM cell switch.

8. The method of claim 1, wherein:
one or more SCells of the LTM candidate cell are activated at a time ‘t’ after completion of an LTM cell; and
the time ‘t’ is one of a configured time or a pre-defined time.

9. The method of claim 1, wherein one or more SCells of the LTM candidate cell are activated at a time ‘t’ after reception of the MAC CE.

10. The method of claim 1, wherein:
the MAC CE includes a transmission configuration indicator (TCI) state for the at least one SCell of the LTM candidate cell to be activated; and
the TCI state for the at least one SCell of the LTM candidate cell is used for that SCell after activation of that SCell.

11. A method of operating a base station (BS), the method comprising:
transmitting (i) a configuration of a layer 1 (L1)/layer 2 (L2) triggered mobility (LTM) candidate cell and (ii) a configuration of one or more secondary cells (SCells) of the LTM candidate cell;
transmitting a medium access control (MAC) control element (CE), wherein the MAC CE is an LTM cell switch MAC CE for switching to the LTM candidate cell; and
activating at least one SCell of the LTM candidate cell.

12. The method of claim 11, wherein:
activating the at least one SCell of the LTM candidate cell comprises transmitting an SCell activation bit in the MAC CE; and
the SCell activation being set to 1 instructs a user equipment (UE) to activate all configured SCells of the LTM candidate cell.

13. The method of claim 11, wherein:
activating the at least one SCell of the LTM candidate cell comprises transmitting the MAC CE as an LTM cell switch command with SCell activation MAC CE; and
the LTM cell switch command with SCell activation MAC CE instructs a user equipment (UE) to activate all configured SCells of the LTM candidate cell.

14. The method of claim 11, wherein:
activating the at least one SCell of the LTM candidate cell comprises transmitting a plurality of SCell activation bits in the MAC CE, each SCell activation bit corresponding with an SCell of the LTM candidate cell; and
the SCell activation bits being set to 1 instructs a user equipment (UE) to activate each of the SCells of the LTM candidate cell corresponding with the SCell activations bits set to 1.

15. The method of claim 11, wherein:
activating the at least one SCell of the LTM candidate cell comprises transmitting an identity of one or more SCells of the LTM candidate cells in the MAC CE; and
the MAC CE instructs a user equipment (UE) to activate the one or more SCells of the LTM candidate cell whose identity is included in the MAC CE.

16. The method of claim 11, wherein:
activating the at least one SCell of the LTM candidate cell comprises setting an sCellState parameter in the configuration of the one or more SCells to active; and
the MAC CE instructs a user equipment (UE) to activate, for each of the sCellState parameters set to active, a corresponding SCell.

17. The method of claim 11, wherein one or more SCells of the LTM candidate cell are activated upon completion of an LTM cell switch.

18. The method of claim 11, wherein:
one or more SCells of the LTM candidate cell are activated at a time ‘t’ after completion of an LTM cell; and
the time ‘t’ is one of a configured time or a pre-defined time.

19. The method of claim 11, wherein one or more SCells of the LTM candidate cell are activated at a time ‘t’ after transmission of the MAC CE.

20. The method of claim 11, wherein:
the MAC CE includes a transmission configuration indicator (TCI) state for the at least one SCell of the LTM candidate cell to be activated; and
the TCI state for the at least one SCell of the LTM candidate cell is used for that SCell after activation of that SCell.
